(19) United States
(12) Patent Application Publication
(10) Pub. No.: US 2006/0110039 A1
(43) Pub. Date: May 25, 2006

(54) Adaptive segmentation of television images

(76) Inventors: Stephen Herman, Monsey, NY (US); Erwin Bellers, Fremont, CA (US)

Correspondence Address: PHILIPS INTELLECTUAL PROPERTY & STANDARDS, P.O. BOX 3001, BRIARCLIFF MANOR, NY, 10510, US

(21) Appl. No.: 10/538,338

(22) PCT Filed: Dec. 5, 2003
(86) PCT No.: PCT/IB03/05756

§ 371 Date: Jun. 10, 2005

Related U.S. Application Data
(60) Provisional application No. 60/433,418, filed on Dec. 13, 2002.

(51) Int. Cl. G06K 9/34

(52) U.S. Cl. 382/173

(57) ABSTRACT

A method (100) and system (600) for adaptively segmenting pixel elements in an image frame is disclosed. The method comprises the steps of segmenting pixel elements into at least one first region based on a selection criteria (110), refining the selection criteria (150) based on information associated with each of the pixel elements within an associated first region and segmenting (160) the image pixel elements into at least one second region based on said refined selection criteria (150).

This invention relates to video processing and more specifically to an adaptive segmentation system based upon characteristics such as color and texture, and in particular to sky detection.

Segmentation of video images, such as television images, is a process wherein each frame of a sequence of images is subdivided into regions or segments. Each segment includes a cluster of pixels that encompass a region of the image with common properties or characteristics. For example, a segment may be distinguished by a common color, texture, shape, amplitude range or temporal variation. Several methods are known for image segmentation using a process wherein a binary decision determines how the pixels will be segmented. According to such a process, all pixels in a region either satisfy a common criteria for a segment and are therefore included in the segment, or do not satisfy the criteria and are completely excluded. While segmentation methods such as theses are satisfactory for some purposes, they are unacceptable for many others.

In conventional methods of segmentation for grass detection, for example, the method based upon a probability distribution function for an expected grass color and luminosity in the YUV domain is representative of a compromise between computational simplicity and algorithmic effectiveness. However, the three-dimensional Gaussian probability function defining the range of expected grass colors and luminosities in the YUV domain had increased expected values which were broad enough to account for possible variations of grass colors from scene to scene. This has the undesired side effect of increasing the false detection rate and declaring non-grass areas “grass.” The same false detection problem arises when the probability function is applied to methods for detecting other similar areas, such as sky areas. In addition, bodies of water may at times be classified as sky areas, for example.

Hence, there is a need for a method and system for adaptively segmenting video images that reduces the false classification of areas within the video images.

A method and system for adaptively segmenting pixel elements in an image frame is disclosed. The method comprises the steps of segmenting pixel elements into a at least one first region based on a selection criteria, refining the selection criteria based on information associated with each of the pixel elements within an associated first region and segmenting the image pixel elements into at least one second region based on said refined selection criteria.

In the drawings:

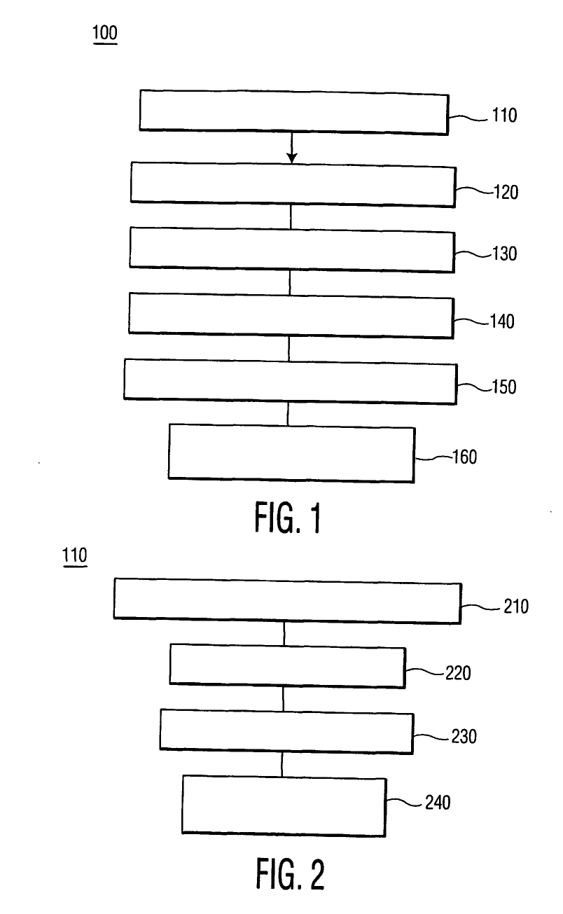

FIG. 1 illustrates a block diagram of an exemplary adaptive segmentation process in accordance with the principles of the present invention;

FIG. 2 illustrates a block diagram of an exemplary process for determining an initial segmentation probability function;

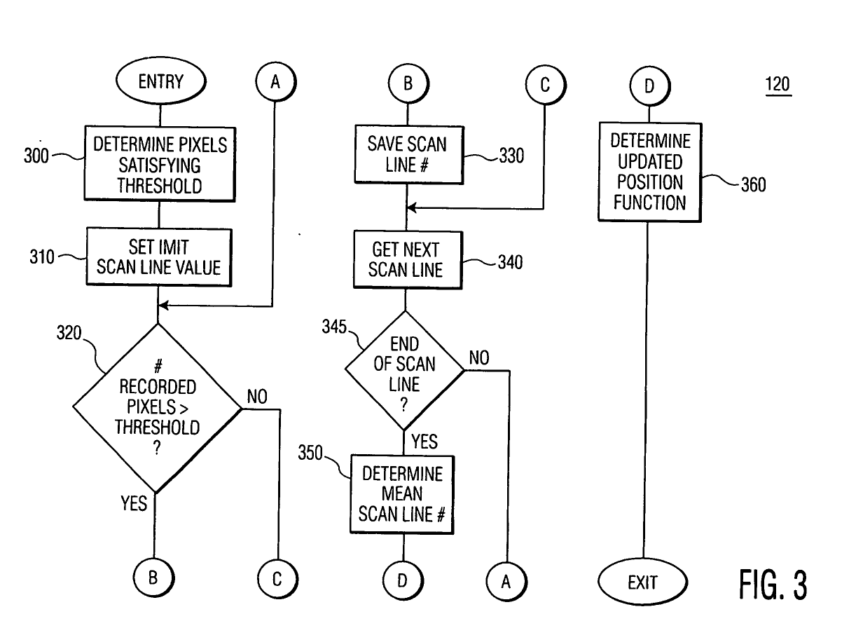

FIG. 3 illustrates a flow chart of an exemplary process for determining an updated probability function in accordance with the principles of the invention;

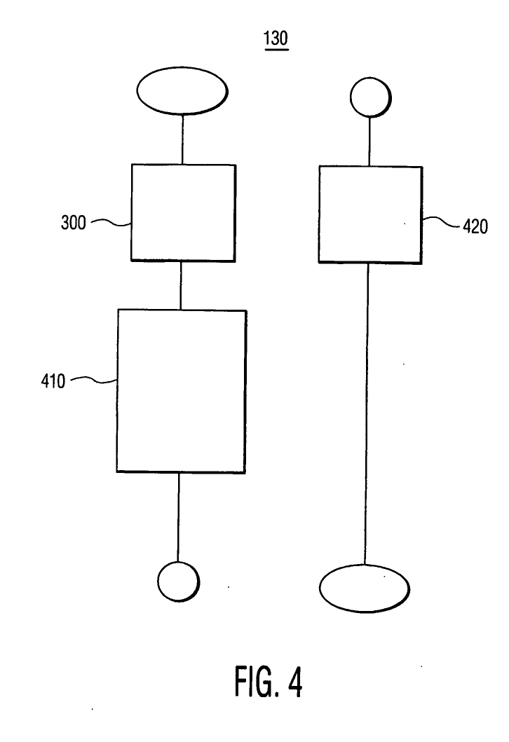

FIG. 4 illustrates a flow chart of an exemplary process for determining an updated color probability function in accordance with the principles of the invention;

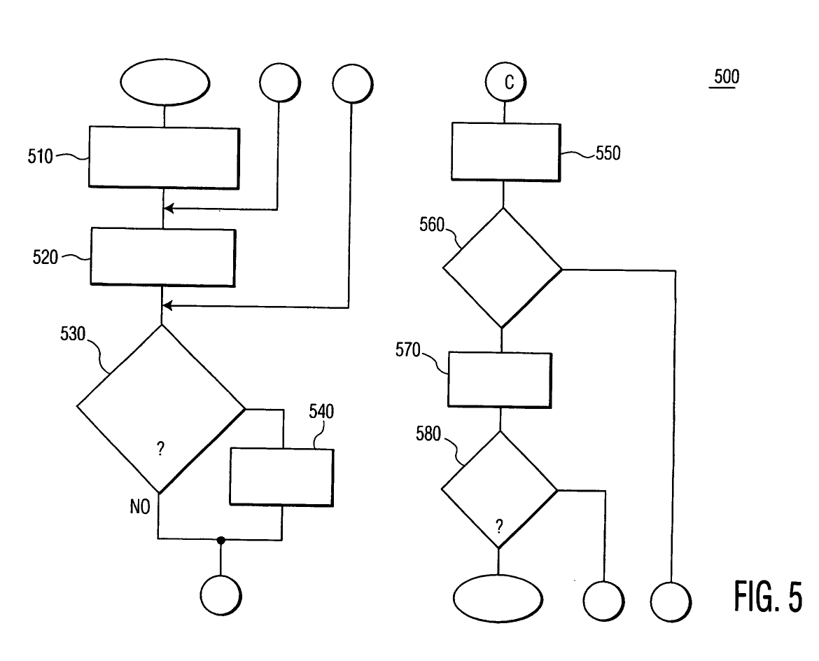

FIG. 5 illustrates a flow chart of an exemplary process for determining pixels used in obtaining updated probability functions in accordance with the principles of the invention; and

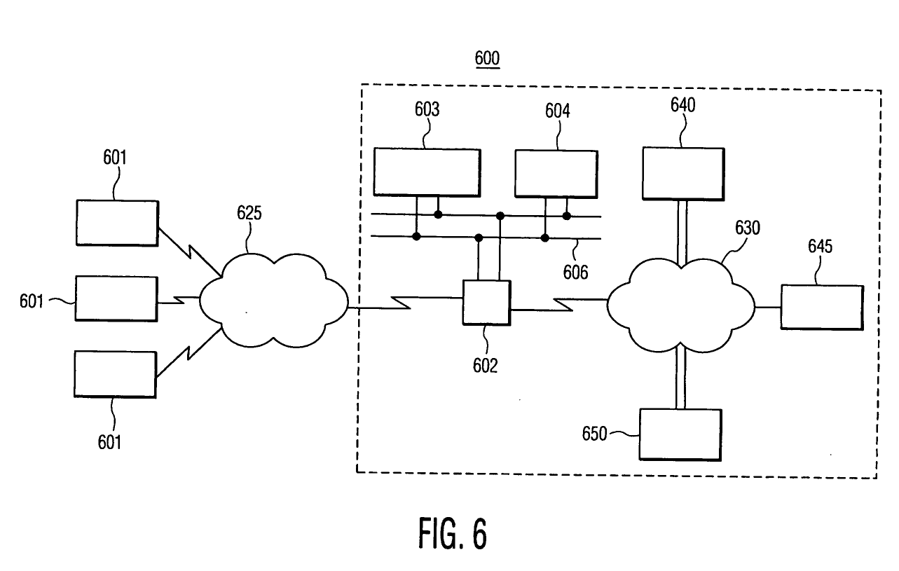

FIG. 6 illustrates a illustrates a system for executing the processing depicted in FIGS. 1-5.

It is to be understood that these drawings are solely for purposes of illustrating the concepts of the invention and are not intended as a definition of the limits of the invention. The embodiments shown in FIGS. 1 through 6 and described in the accompanying detailed description are to be used as illustrative embodiments and should not be construed as the only manner of practicing the invention. The same reference numerals, possibly supplemented with reference characters where appropriate, have been used to identify similar elements.

Video images may have significant areas or segments that may be identified as having substantially the same characteristics, e.g., color, luminese, texture. For example, a segment of an image may contain information related to a sky, i.e., blue color, smooth texture. Similarly, fields of grass may be identified by its green color and semi-smooth texture. Identification of areas, or segments of video images are more fully discussed in the commonly assigned, co-pending patent application Ser. No. ______, entitled “Automatic Segmentation-based Grass Detection for Real-Time Video,” and commonly assigned co-pending patent application Ser. No. ______, entitled, System and Method for Performing Segmentation-Based Enhancements of a Video Image.”

FIG. 1 illustrates a block diagram 100 of an exemplary adaptive segmentation process in accordance with the principles of the invention. In this embodiment, an initial segmentation probability function is determined at block 110. As will be discussed, the initial probability function may be determined as a function of one or more probability functions including position, color and texture. At block 120, an updated position probability function is determined at block 120. At block 130, an updated color probability function is determined and at block 140 an updated texture probability function is determined. At block 150, an updated probability function is determined. The updated probability function is representative of a composite of the updated probability functions. At block 160, the image is re-evaluated using the updated probability function. In another aspect, the processing and the refinement of the probability distribution functions may be performed in parallel.

FIG. 2 illustrates an exemplary process 110 for determining an initial probability function for segmentation. In this exemplary process, an initial position probability function is determined at block 210, an initial color probability function is determined at block 220 and an initial texture probability function is determined at block 230. At block 240, an initial segmentation probability function is determined in relation to the determined individual probability functions. With particular application to those areas of an image that may be related to the sky, a position function may assume that the sky is conventionally near a top of the image. Accordingly, a position probability function may be determined as:

$${p}_{position} = {ⅇ}^{- {( \frac{L}{( \# lines )} )}^{2}} \qquad [ 1 ]$$

where L=line number, starting from 0 at the top, and
#lines=the total number of scan lines per frame.

Similar probability distributions may be determined for other known regions, such as grass, water, faces, etc. In one aspect, the position probability distribution may be set to 1, i.e., uniform distribution, to indicate that no preference in position may be assumed or determined. In this case, the entire image may be associated with the known region.

An initial color probability distribution of the sky may be represented as:

$${p}_{color} = {ⅇ}^{- [ {( \frac{y - y0}{{σ}_{y}} )}^{2} + {( \frac{u - u0}{{σ}_{u}} )}^{2} + {( \frac{v - v0}{{σ}_{v}} )}^{2} ]} \qquad [ 2 ]$$

where, initial starting values for sky detection may be set, on a scale of 0-255, as:
y0=210, σy=130;
u0=150, σu=40; and
v0=100, σv=40.

These parameters are determined empirically by examining a large number of sky images. However, it should be understood that other initial values may be used without altering the processing or the scope of the invention. Further, one skilled in the art will recognize that similar initial y, u, and v values for other image regions, such as grass, water, faces, etc, may be determined.

An initial texture probability function may be determined as:

$$\begin{matrix}{p}_{texture} = {ⅇ}^{- 0.2 * {( t - t0 )}^{2}} for t > t0 and \\ = 1 ; for t < t0\end{matrix} \qquad [ 3 ]$$

where t0=10 for low noise; and
=40 for SNR=26 dB; and
t is the sum of the absolute differences of 5 adjacent horizontal luminance values of a running window centered at the current pixel.

Similar probability distributions may be determined for other textures. In one aspect, the textual probability distribution may be set to 1, i.e., uniform distribution, to indicate that no preference in texture may be assumed or determined. In this case, the entire image may be associated with the known texture.

An initial probability function may be determined as:
P=P_{color}*Pₚₒₛᵢₜᵢₒₙ*Pₜₑₓₜᵤᵣₑ [4]

Pixel elements matching or satisfying the selection criteria, as represented by P may be broadly classified, identified or associated with a known region of the image. In this manner, the broad and not very selective probability function reduces the chance of not detecting pixels within a desired region of interest.

Although, the probability function shown in equation 4 is determined in association with probability functions associated with color, position and texture, it will be understood by those skilled in the art that the probability function, P, may be similarly determined based only on a single or any combination of the probability functions discussed or other characteristics of an image.

FIG. 3 illustrates a flow chart of the exemplary process 120 for updating or refining the position probability function shown in FIG. 1 in accordance with the principles of the invention. In this exemplary process, those pixels in the image satisfying a known position criteria are identified and tagged at block 300. Determination and identification of pixels satisfying a known threshold criteria associated with position will be discussed in more detail with regard to FIG. 5.

At block 310, an initial scan line value is established or set. At block 320, a determination whether the number of pixels with a scan line satisfying the known position criteria is greater than a known threshold value. If the answer is in the negative, than a next scan line is obtained a block 350. A determination is then made at block 345 whether all the scan lines have been evaluated. If the answer is in the negative, then processing continues at block 320 to determine whether the number of pixels in the selected or obtained next scan line is greater than a known positional threshold.

Returning to block 320, if the answer affirmative, the scan line number that has a number of pixels satisfying the position criteria is saved or recorded for further processing at block 330. A next/subsequent scan line is selected or obtained at block 340 for processing.

Returning to block 345, if the answer is affirmative, i.e., all scan lines have been processed, the mean scan line value of the recorded or stored scan line values is determined at block 350. Using the mean scan line value the positional probability function is updated at block 360.

In one aspect of the invention, scan lines may be numbered from top-to bottom and the pixels in each scan line numbered left-to-right. In this manner each pixel may be uniquely identified. Furthermore, a next/subsequent scan line or pixel may be selected or obtained from a preceding scan line or pixel by incrementing a scan line or pixel number. Similar methods of identifying and selecting scan lines and associated pixel elements are well-known and need not be discussed in detail herein.

In one embodiment of the invention, a positional threshold criteria may be selected with regard to a probability function as:
Kₗ*maximum(P) [5]
where K₁ is a known percentage of the maximum probability function.

In a preferred embodiment, K₁ is set to 0.5. Hence, in the preferred embodiment, those pixels (i) in each scan line (j) satisfying the criteria
Pᵢⱼ>0.5*maximum(P) [6]
are identified, stored or retained for subsequent processing.

An updated positional probability function may be then determined as:

$${P}_{position2} = \frac{( 3 * s - L )}{( 3 * s )} > 0 \qquad [ 7 ]$$

where L=scan line number (0 at the top); and
s=is the mean scan line value determined in block 350.

In another aspect of the invention, the scan line values are stored when it is determined that a sufficient percentage of pixels within a scan line satisfy the criteria shown in Equation 5. For example, a scan line is saved when the number of pixels satisfying the preferred criteria shown in Equation 6 exceeds for example, three percent (3%) of the total number of pixels in a selected scan line. Accordingly, in this aspect of the invention, a scan line is stored or recorded when:
# pixels satisfying equation 6>(Total #.pixel in scan line)K₂ [8]
where K₂ is<=32.

In a preferred embodiment K₂ is equal to 32.

FIG. 4 illustrates a flow chart of an exemplary process 130 depicted in FIG. 1 for updating a color probability function. In this exemplary process a number of pixels in each scan line satisfying a known color-related threshold value are determined at block 300.

At block 410, a mean value corresponding to the each color level associated with each pixel satisfying the known color threshold is then determined. At block 420, an updated color probability function may be determined using the determined mean color values. Determination and identification of pixels satisfying a known threshold criteria associated with color will be discussed in more detail with regard to FIG. 5.

In one embodiment of the invention, a color criteria may be selected with regard to a probability function as:
K₃*maximum(P) [9]
where K₃ is a known percentage of the maximum probability function.

In a preferred embodiment, K₃ is set to 0.95. Hence, in the preferred embodiment, those pixels (i) in each scan line (j) satisfying the criteria
Pᵢⱼ>0.95*maximum(P) [10]
are identified, stored or retained for subsequent processing.

Mean color values associated with each pixel satisfying the color criteria of equation 10 may be determined as:

$${y}_{1} = \frac{{\sum }_{1}^{N} {y}_{ij}}{N} , {u}_{1} = \frac{{\sum }_{1}^{N} {u}_{ij}}{N} , {v}_{1} = \frac{{\sum }_{1}^{N} {v}_{ij}}{N} \qquad [ 11 ]$$

where yᵢⱼ, uᵢⱼ, vᵢⱼ are representative of the color levels of the ij^{th} pixel; and
N is the total number of pixels satisfying the color criteria.

An updated color probability function may then be determined by:

$${p}_{color2} = {ⅇ}^{- [ {( \frac{y - y1}{k * {σ}_{y}} )}^{2} + {( \frac{u - u1}{k * {σ}_{u}} )}^{2} + {( \frac{v - v1}{k * {σ}_{v}} )}^{2} ]} \qquad [ 12 ]$$

It should be appreciated by those skilled in the art, that the denominators of each term in the exponent have been multiplied by a factor k, wherein k is less than one (1). Use of the factor k is advantageous as it results in a smaller sigma value and consequentially to a distribution that is more peaked or concentrated. In this manner, the selection of pixels in a region is limited by the narrower or concentrated distribution function. In a preferred embodiment, k may be equal to 0.5.

An updated texture probability function, pₜₑₓₜᵤᵣₑ₂, may then be determined as:
pₜₑₓₜᵤᵣₑ₂=e^{-0.2*(u)}^{²} [13]
where tt is the absolute difference of luminance values of a current pixel and the following one on the same line.

Although, an updated texture probability is determined with regard to an difference in luminance values as described in equation 13, it should be understood that an updated texture probability may determined using pixels satisfying a known texture-related threshold value similar to that disclosed with regard to an updated position or color probability density, as discussed previously.

An updated probability function may then be determined as:
Pᵤ=P_{color2}*Pₚₒₛᵢₜᵢₒₙ₂*Pₜₑₓₜᵤᵣₑ₂ [14]

The updated probability function Pᵤ may then be used to re-classify each pixel in the image to refine the determination of those pixels within desired or designated areas or regions of interest. For example, updated probability distribution function Pᵤ may be used to refine the determination of those pixels in, for example, sky, grass, or face regions of an image.

FIG. 5 illustrates a flow chart 500 of the exemplary process 300, shown in FIG. 3, for determining pixel elements that satisfy a threshold criteria associated with a positional probability function, and in FIG. 4 for determining pixel elements that satisfy a threshold criteria associated with a color probability function. Hence, when an updated positional probability function is to be determined, a threshold criteria may be determined in accordance with equation 5, and in addition equation 8. And, when an updated color probability function is to be determined, then the threshold criteria may be determined in accordance with equation 9.

In flow chart 500, an initial scan line value is set or an initial scan line is selected at block 510. Preferably, an initial scan line is set to the top-most line, i.e., zero line, of the image. At block 520, an initial pixel position within the selected scan line is selected. At block 530 a determination is made whether the probability associated with the selected pixel is greater than a known threshold value or criteria. If the answer is in the affirmative, the identification of the pixel satisfying the threshold criteria is stored or recorded at block 540. However, if the answer is negative, then a next/subsequent pixel in the selected scan line is selected at block 550. At block 560, a determination is made whether all pixels on the selected scan line have been processed. If the answer is in the negative, then processing continues at block 530 to determine whether the next/subsequent pixel selected is greater than the known threshold.

However, if the answer at block 560 is affirmative, then a next/subsequent scan line is selected at block 570. At block 580, a determination is made whether all the scan lines in the image have been processed. If the answer is in the negative, then processing continues at block 520 to select a pixel element associated with the selected next/subsequent scan line. If, however, the answer to the determination at block 580 is in the affirmative, then process is completed.

FIG. 6 illustrates an exemplary embodiment of a system 600 that may be used for implementing the principles of the present invention. System 600 may represent a real-time receiving system, such as an SDTV or HDTV television, a desktop, laptop or palmtop computer, a personal digital assistant (PDA), a video/image storage apparatus such as a video cassette recorder (VCR), a digital video recorder (DVR), a TiVO apparatus, etc., as well as portions or combinations of these and other devices. System 600 may contain one or more input/output devices 602, processors 603 and memories 604. I/O devices may access or receive information from one or more sources 601 that contain video images. Sources 601 may be stored in permanent or semi-permanent media such as a television receiving system, a VCR, RAM, ROM, hard disk drive, optical disk drive or other video image storage devices. Sources 601 may alternatively be accessed over one or more network connections 625 for receiving video from a server or servers over, for example a global computer communications network such as the Internet, a wide area network, a metropolitan area network, a local area network, a terrestrial broadcast system (Radio, TV), a cable network, a satellite network, a wireless network, or a telephone network, as well as portions or combinations of these and other types of networks.

Input/output devices 602, processors 603 and memories 604 may communicate over a communication medium 606. Communication medium 606 may represent, for example, a bus, a communication network, one or more internal connections of a circuit, circuit card or other apparatus, as well as portions and combinations of these and other communication media. Input data from the sources 601 is processed in accordance with one or more programs that may be stored in memories 604 and executed by processors 603. Processors 603 may be any means, such as general purpose or special purpose computing system, or may be a hardware configuration, such as a laptop computer, desktop computer, handheld computer, dedicated logic circuit, integrated circuit. Processors 603 may also be Programmable Array Logic (PAL), Application Specific Integrated Circuit (ASIC), etc., which may be hardware “programmed” to include software instructions that provide a known output in response to known inputs.

In one embodiment, the coding employing the principles of the present invention may be implemented by computer readable code executed by processor 603. The code may be stored in the memory 604 or read/downloaded from a memory medium such as a CD-ROM or floppy disk (not shown). In a preferred embodiment hardware circuitry may be used in place of, or in combination with, software instructions to implement the invention. For example, the elements illustrated herein may also be implemented as discrete hardware elements that are operable to perform the operations shown using coded logical operations or by executing hardware executable code.

Data from the source 601 received by I/O device 602 after processing in accordance with one or more software programs operable to perform the functions illustrated in FIGS. 2 and 3, which may be stored in memory 604 and executed by processor 603 may then be transmitted over network 630 to one or more output devices represented as TV monitor 640, storage device 645 or display 650. As will be appreciated, TV monitor 640 may be an analog or digital TV monitor.

The term computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

1. A method (100) for adaptively segmenting pixel elements in an image frame comprising the steps of:
segmenting pixel elements into at least one first region based on a selection criteria (110);
refining said selection criteria (150) based on information associated with each of said pixel elements within an associated first region; and
segmenting (160) said image pixel elements into at least one second region based on said refined selection criteria.

2. The method as recited in claim 1, wherein said selection criteria is a probability function determined in association with a probability function (120, 130, 140) selected from the group consisting of: color, textual, and position.

3. The method as recited in claim 2, wherein said positional probability function is associated with a known portion of said image (210).

4. The method as recited in claim 3, wherein said known image portion is associated with an upper half of said image.

5. The method as recited in claim 2, wherein said color probability function is associated with the group comprising: color, luminosity in the YUV domain.

6. The method as recited in claim 2, wherein said textual probability function is associated with a group of adjacently located pixel elements (230).

7. The method as recited in claim 3, wherein said known image portion is said image.

8. The method as recited in claim 2, wherein said step of refining said selection criteria comprises the steps of:
determining a threshold criteria associated with each of said selected probability functions;
identifying said pixel elements satisfying (320, 410,530) said threshold criteria;
determining an updated probability function (360, 420) for each of said selected probability functions based on said identified pixel elements; and
determining said refined selection criteria (150) in conjunction with said updated probability functions.

9. The method as recited in claim 8, wherein said threshold criteria is a known factor of said selection criteria.

10. The method as recited in claim 9, wherein said known factor is based on said selected probability distribution.

11. A system (600) for adaptively segmenting pixel elements in an image frame comprising:
means (603, 604) for segmenting said pixel elements into a at least one first region based on a selection criteria (110);
means (603, 604) for refining said selection criteria based on information associated with each of said pixel elements within an associated region (150); and
means for segmenting (160) said image pixel elements into a at least one second region based on said refined selection criteria.

12. The system as recited in claim 11, wherein said selection criteria is a probability function determined in association with at least one probability function (120, 130, 140) selected from the group comprising: color, textual, position.

13. The system as recited in claim 12, wherein said positional probability function is associated with a known portion of said image (210).

14. The system as recited in claim 13, wherein said known image portion is associated with an upper half of said image.

15. The system as recited in claim 12, wherein said color probability function is associated with the group comprising: color, luminosity in the YUV domain.

16. The system as recited in claim 12, wherein said textual probability function is associated with a group of adjacently located pixel elements (230).

17. The system as recited in claim 13, wherein said known image portion is said image.

18. The system as recited in claim 12, further comprising:
means for determining a threshold criteria associated with each of said selected probability functions;
means for identifying said pixel elements satisfying (320, 410, 530) said threshold criteria;
means for determining an updated probability function (360, 420) for each of said selected probability functions based on said identified pixel elements; and
means for determining said refined selection criteria (150) in conjunction with said updated probability functions.

19. The system as recited in claim 18, wherein said threshold criteria is a known factor of said selection criteria.

20. The system as recited in claim 19, wherein said known factor is based on said selected probability distribution.

21. The system as recited in claim 11, further comprising:
means (602) for receiving said pixel elements from at least one input source.
